(19) United States
(12) Patent Application Publication
(10) Pub. No.: US 2008/0100063 A1
(43) Pub. Date: May 1, 2008

(54) Flange coupling member

(75) Inventors: Dan Thomas Benson, Tomball, TX (US); Ricky Edward Pineda, Pearland, TX (US)

Correspondence Address: DUANE MORRIS LLP, 3200 SOUTHWEST FREEWAY, SUITE 3150, HOUSTON, TX, 77027, US

(73) Assignee: Oceaneering International, Inc.

(21) Appl. No.: 11/588,547

(22) Filed: Oct. 27, 2006

(51) Int. Cl. F16L 25/00

(52) U.S. Cl. 285/332.1

(57) ABSTRACT

This invention is directed to a flange coupling member for connecting pipe sections, including subsea pipe sections. The invention uses an elastomeric band, a tapered cone ring and a tapered slip ring to provide a coupling capability. Additionally, the present invention uses a flange that is detachably connected to the housing.

### FIELD OF THE INVENTION

This invention is directed to a flange coupling member for connecting pipe sections, including subsea pipe sections. The invention uses an elastomeric band, a tapered cone ring and a tapered slip ring to provide a coupling capability. Additionally, the present invention uses a flange that is detachably connected to the housing.

### BACKGROUND OF THE INVENTION

Prior art pipe coupling devices, such as those disclosed in U.S. Pat. Nos. 4,822,075, 5,056,830, 5,209,522, and 5,456,501 to Reaux, use a piston or piston means to actuate one or more gripping slips and one or more elastomeric seals. The present invention eliminates the need for a piston in a coupling device is which slips are actuated. This reduced the number of components and the cost of manufacturing for the invention as compared with these prior art coupling devices.

It is desirable to have a detachable flange on pipe coupling devices so that the flange can be replaced when the pressure class of the coupled pipe changes. Without a detachable flange, the entire coupling device must be replaced when the pressure class of the coupled pipe changes. This invention provides an advantage over prior art coupling devices that do not provide detachable flanges.

### DESCRIPTION OF THE DRAWINGS

FIG. 1 is a side cross sectional view of one embodiment of the invention.

FIG. 2 is an exploded isometric view of an embodiment of the invention.

### DETAILED DESCRIPTION OF THE PREFERRED EMBODIMENTS

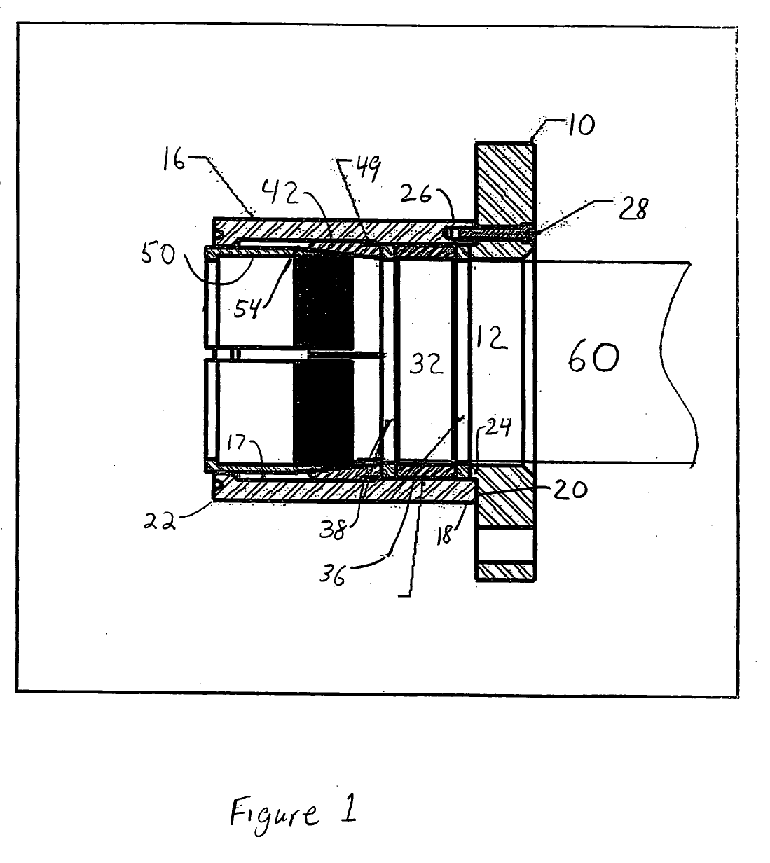

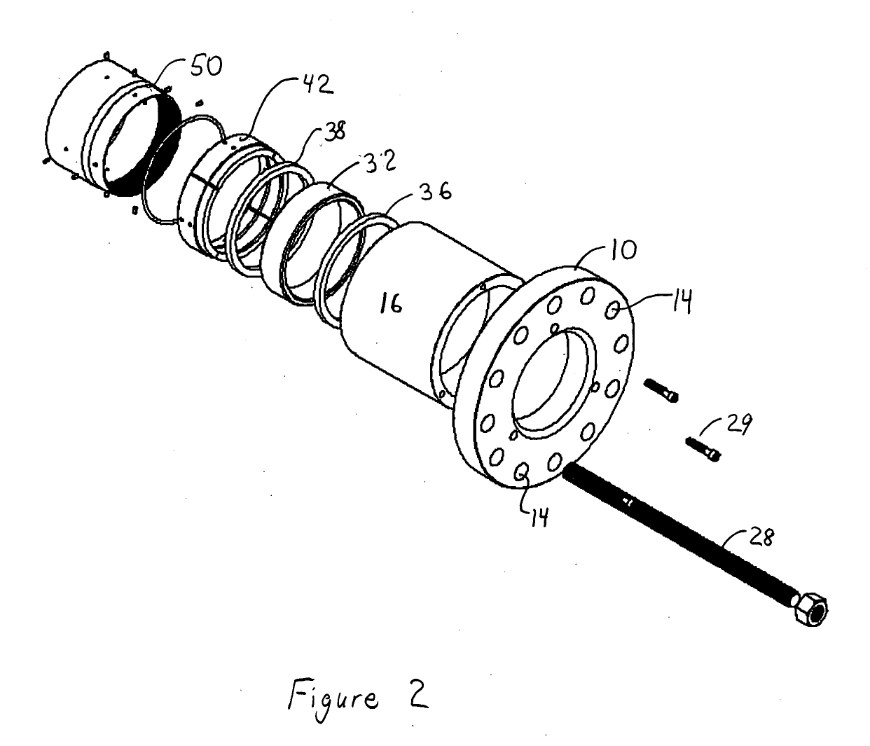

The embodiments described herein are shown in FIGS. 1-2. A preferred embodiment of the invention is directed toward a flanged coupling. A first preferred embodiment comprises a flange 10 comprising a first outer diameter, a first inner diameter defining a longitudinal flange channel 12 and at least two threaded flange channels 14 on opposite sides of the longitudinal channel. In a preferred embodiment, the flange is made from material comprising one or more of the following steel alloys: A105, A694, A350, 4130, 4140, 8620, or 8630. In another preferred embodiment, the flange comprises at least four threaded flange channels. In another preferred embodiment, the flange is a detachable butt flange.

This preferred embodiment further comprises a housing 16 having a first inner surface 17, a second outer diameter that is less than the first outer diameter, a second inner diameter that is greater than the first inner diameter, a distal end 18 comprising a distal face 20, and a proximal end 22 opposite the distal end. The distal end is detachably connected to the flange such that the portion of the flange whose diameter is less than the second inner diameter forms an inner lip section 24 which defines an annular cavity with the first inner surface. The distal face comprising at least two threaded housing channels 26, each of which is positioned in longitudinal alignment with one of the threaded flange channels to form an aligned channel pair. In another preferred embodiment, the distal face comprises at least four threaded housing channels, each of which is positioned in longitudinal alignment with one of the threaded flange channels to form an aligned channel pair.

In a preferred embodiment, the housing is made from a ring forging. In another preferred embodiment, the housing is made from material comprising one or more of the following steel alloys: A105, A694, A350, 4130, 4140, 8620, or 8630. In another preferred embodiment, the housing is cylindrical. In yet another preferred embodiment, the flange is a swivel ring flange.

This preferred embodiment further comprises a first threaded member 28 extending through one of the aligned channel pairs and a second threaded member 29 extending through another of the aligned channel pairs. In a preferred embodiment comprising four aligned channel pairs, there is a threaded member extending through each aligned channel pair. Each threaded member provides a means for detachably connecting the flange to the housing. In one preferred embodiment, the threaded member is a screw. In another preferred embodiment, each threaded member is a bolt. Other means well known to persons skilled in the mechanical arts may be used to detachably connect the flange to the housing. Such means for detachably connecting the flange to the housing include screwing a threaded flange and a threaded housing together.

This preferred embodiment further comprises an elastomeric band 30 in the annular cavity comprising a central elastomeric region 32, a first end region comprising a first anti-extrusion ring 38, a second end region opposite the first end region and comprising a second anti-extrusion ring 36. In the preferred embodiment shown in FIG. 3, the first and second anti-extrusion rings are detachable from the central elastomeric region of the elastomeric band. In a preferred embodiment, the anti-extrusion rings are made from material comprising a steel alloy and an elastomeric or thermoplastic material. Suitable steel alloys include A36, A572, A105, A694, A350, 4130, 4140, 8620, and 8630 as well as stainless steel alloys 304, 316, and 17-4. Suitable thermoplastic materials include acetal, ultrahigh molecular weight polyethylene (UHMW), and tetrafluoroethylene (TFE) thermoplastics. Suitable elastomers include buna nitrile (NBR), hydrogenated buna nitrile (HNBR), fluorocarbon elastomer (FKM), polyurethane (PUR), and TFE/propylene (TFE/P). In a preferred embodiment, these elastomers have a hardness greater than 85 Shore A. In a preferred embodiment, the central elastomeric region is made from a material comprising NBR, HNBR, FKM, PUR, and TTE/P elastomers. In a preferred embodiment, these elastomers have a hardness less than 85 Shore A. The external elastomer region will extrude through the annular gap between the pipe and the coupling under pressure. The band further comprises a third inner diameter substantially equivalent to the first inner diameter and a third outer diameter substantially equivalent to the second inner diameter. The band is positioned such that its second anti-extrusion ring is adjacent to the inner lip.

This preferred embodiment further comprises a cone ring 42 comprising an outer surface comprising a diameter that is substantially equivalent to the second inner diameter of the housing, a tapered inner surface, a first end adjacent to the first anti-extrusion ring, and a shoulder 49 that limits axial motion of the cone ring with respect to the housing. In a preferred embodiment, the tapered inner surface has a taper angle in the range of 5-10 degrees.

In a preferred embodiment, the cone ring is made from material comprising one or more of the following alloys: 4130, 4140, 8620, or 8630 steel, or 304, 316, or 17-4 stainless steel. In another preferred embodiment, the cone ring is cylindrical.

This preferred embodiment further comprises a split slip ring 50 comprising an inner surface defining a longitudinal channel having an inner diameter substantially equivalent to the first inner diameter, an outer surface comprising a tapered region 54 adjacent to the cone ring the cone ring such that longitudinal movement of the cone ring toward the slip ring causes the tapered inner surface of the slip ring to contract radially inward as it slides along the tapered region of the cone ring. In a preferred embodiment, the tapered region of the outer surface has a taper angle that is substantially equivalent to the taper angle of the inner surface of the cone ring.

In a preferred embodiment, the split ring is made from material comprising one or more of the following alloys: 4130, 4140, 8620, or 8630 steel, or 304, 316, or 17-4 stainless steel. In another preferred embodiment, the split ring is cylindrical.

In another preferred embodiment, the invention comprises a pipe 60 having an outer diameter substantially equivalent to the first inner diameter and inserted to extend through the first inner diameter of the flange, the third inner diameter of the band, the fourth inner diameter of the anti-extrusion ring, and the inner surface of the slip ring. In a preferred embodiment, the pipe comprises a fluid, including water, oil, gas, or petroleum. In another preferred embodiment, the pipe is connected to a subsea tie-back, or a subsea pipeline, including an export pipeline.

It will be understood that various changes in size, shape, detail, parameters, and arrangements of the embodiments which have been described and illustrated above in order to explain the nature of this invention may be made by those skilled in the art without departing from the principle and scope of the invention.

What is claimed is:

1. A flanged coupling member comprising:
a. a flange comprising a first outer diameter, a first inner diameter defining a longitudinal flange channel and at least two threaded flange channels on opposite sides of the longitudinal channel;
b. a housing having a first inner surface, a second outer diameter that is less than the first outer diameter, a second inner diameter that is greater than the first inner diameter, a distal end comprising a distal face, and a proximal end opposite the distal end, said distal end being detachably connected to the flange such that the portion of the flange whose diameter is less than the second inner diameter forms an inner lip section which defines an annular cavity with the first inner surface, said distal face comprising at least two threaded housing channels, each of which is positioned in longitudinal alignment with one of the threaded flange channels to form an aligned channel pair;
c. a first threaded member extending through one of the aligned channel pairs;
d. a second threaded member extending through another of the aligned channel pairs;
e. an elastomeric band in said annular cavity comprising a central elastomeric region, a first end region comprising a first anti-extrusion ring, a second end region opposite the first end region and comprising a second anti-extrusion ring, said band further comprising a third inner diameter substantially equivalent to the first inner diameter, and a third outer diameter substantially equivalent to the second inner diameter, said band being positioned such that its second anti-extrusion ring is adjacent to said inner lip;
f. a cone ring comprising an outer surface comprising a diameter that is substantially equivalent to the second inner diameter of the housing, a tapered inner surface, a first end adjacent to the first anti-extrusion ring, and a shoulder that limits axial motion of the cone ring with respect to the housing; and
g. a split slip ring comprising an inner surface defining a longitudinal channel having an inner diameter substantially equivalent to the first inner diameter, an outer surface comprising a tapered region adjacent to the cone ring such that longitudinal movement of the cone ring toward the slip ring causes the tapered inner surface of the slip ring to contract radially inward as it slides along the tapered region of the cone ring.

2. The coupling member of claim 1, further comprising a pipe having an outer diameter substantially equivalent to the first inner diameter and inserted to extend through the first inner diameter of the flange, the third inner diameter of the band, the fourth inner diameter of the anti-extrusion ring, and the inner surface of the slip ring.

3. The coupling member of claim 2, wherein the pipe is connected to a subsea pipeline.

4. The coupling member of claim 1, wherein the housing, the cone ring and the split ring are cylindrical.

5. The coupling member of claim 1, wherein the flange is made from material selected from the group consisting of A105, A694, A350, 4130, 4140, 8620, and 8630 steel.

6. The coupling member of claim 1, wherein the housing is made from material selected from the group consisting of A105, A694, A350, 4130, 4140, 8620, and 8630 steel.

7. The coupling member of claim 1, wherein the cone ring is made from material selected from the group consisting of 4130 steel, 4140 steel, 8620 steel, 304 stainless steel, 316 stainless steel, and 17-4 stainless steel.

8. The coupling member of claim 1, wherein the split ring is made from material selected from the group consisting of 4130 steel, 4140 steel, 8620 steel, 304 stainless steel, 316 stainless steel, and 17-4 stainless steel.

9. The coupling member of claim 1, wherein the inner surface of the cone ring has a taper angle in the range of 5-10 degrees and the outer surface of the split ring has a taper angle that is substantially equivalent to the taper angle of the inner surface of the cone ring.

10. A flanged coupling member comprising:
a. a flange comprising a first outer diameter, a first inner diameter defining a longitudinal flange channel and at least two threaded flange channels on opposite sides of the longitudinal channel;
b. a cylindrical housing having a first inner surface, a second outer diameter that is less than the first outer diameter, a second inner diameter that is greater than the first inner diameter, a distal end comprising a distal face, and a proximal end opposite the distal end, said distal end being detachably connected to the flange such that the portion of the flange whose diameter is less than the second inner diameter forms an inner lip section which defines an annular cavity with the first inner surface, said distal face comprising at least two threaded housing channels, each of which is positioned in longitudinal alignment with one of the threaded flange channels to form an aligned channel pair;
c. a first threaded member extending through one of the aligned channel pairs;
d. a second threaded member extending through another of the aligned channel pairs;
e. an elastomeric band in said annular cavity comprising a central elastomeric region, a first end region comprising a first anti-extrusion ring, a second end region opposite the first end region and comprising a second anti-extrusion ring, said band further comprising a third inner diameter substantially equivalent to the first inner diameter, and a third outer diameter substantially equivalent to the second inner diameter, said band being positioned such that its second anti-extrusion ring is adjacent to said inner lip, wherein the first and second anti-extrusion rings are made from a material comprising a steel alloy and an elastomeric material;
f. a cylindrical cone ring comprising an outer surface comprising a diameter that is substantially equivalent to the second inner diameter of the housing, a tapered inner surface, a first end adjacent to the first anti-extrusion ring, and a shoulder that limits axial motion of the cone ring with respect to the housing; and
g. a cylindrical split slip ring comprising an inner surface defining a longitudinal channel having an inner diameter substantially equivalent to the first inner diameter, an outer surface comprising a tapered region adjacent to the cone ring such that longitudinal movement of the cone ring toward the slip ring causes the tapered inner surface of the slip ring to contract radially inward as it slides along the tapered region of the cone ring.

11. The coupling member of claim 10, wherein the flange is made from material selected from the group consisting of A105, A694, A350, 4130, 4140, 8620, and 8630 steel.

12. The coupling member of claim 10, wherein the housing is made from material selected from the group consisting of A105, A694, A350, 4130, 4140, 8620, and 8630 steel.

13. The coupling member of claim 10, wherein the cone ring is made from material selected from the group consisting of 4130 steel, 4140 steel, 8620 steel, 304 stainless steel, 316 stainless steel, and 17-4 stainless steel.

14. The coupling member of claim 10, wherein the inner surface of the cone ring has a taper angle in the range of 5-10 degrees and the outer surface of the split ring has a taper angle that is substantially equivalent to the taper angle of the inner surface of the cone ring.

15. The coupling member of claim 1, further comprising a pipe connected to the flange.

16. A flanged coupling member comprising:
a. a flange comprising a first outer diameter, a first inner diameter defining a longitudinal flange channel and at least two threaded flange channels on opposite sides of the longitudinal channel;
b. a housing having a first inner surface, a second outer diameter that is less than the first outer diameter, a second inner diameter that is greater than the first inner diameter, a distal end comprising a distal face, and a proximal end opposite the distal end, said distal end being detachably connected to the flange such that the portion of the flange whose diameter is less than the second inner diameter forms an inner lip section which defines an annular cavity with the first inner surface;
c. an elastomeric band in said annular cavity comprising a central elastomeric region, a first end region comprising a first anti-extrusion ring, a second end region opposite the first end region and comprising a second anti-extrusion ring, said band further comprising a third inner diameter substantially equivalent to the first inner diameter, and a third outer diameter substantially equivalent to the second inner diameter, said band being positioned such that its second anti-extrusion ring is adjacent to said inner lip;
d. a cone ring comprising an outer surface comprising a diameter that is substantially equivalent to the second inner diameter of the housing, a tapered inner surface, a first end adjacent to the first anti-extrusion ring, and a shoulder that limits axial motion of the cone ring with respect to the housing; and
g. a split slip ring comprising an inner surface defining a longitudinal channel having an inner diameter substantially equivalent to the first inner diameter, an outer surface comprising a tapered region adjacent to the cone ring such that longitudinal movement of the cone ring toward the slip ring causes the tapered inner surface of the slip ring to contract radially inward as it slides along the tapered region of the cone ring.

17. The coupling member of claim 16, further comprising a pipe connected to the flange.

18. The coupling member of claim 17, wherein the pipe is connected to a subsea pipeline.

19. The coupling member of claim 18, wherein the pipeline comprises a fluid selected from the group comprising oil, gas, or petroleum.

20. The coupling member of claim 17, wherein the pipe is connected to a subsea tie-back.
